(19) United States
(12) Patent Application Publication
(10) Pub. No.: US 2008/0075511 A1
(43) Pub. Date: Mar. 27, 2008

(54) Method for Position Acquisition for Use with a Hand-operated Printer

(76) Inventors: William Henry Reed, Lexington, KY (US); Michael David Stilz, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/533,787

(22) Filed: Sep. 21, 2006

(51) Int. Cl. B41J 3/36

(52) U.S. Cl. 400/88

(57) ABSTRACT

A method for position acquisition for use with a hand-operated printer includes activating the hand-operated printer to make navigation calculations that are based on reading a first sensor and a second sensor; moving the hand-operated printer until a field of view of each of the first sensor and the second sensor are simultaneously located on a first edge of a print medium to define a zero-crossing point of a first navigational axis; subsequently moving the hand-operated printer until the field of view of each of the first sensor and the second sensor are simultaneously located on a second edge of the print medium to define a zero-crossing point of a second navigational axis; and defining a rectilinear grid based on the first navigational axis and the second navigational axis for association with the print medium.

### FIELD OF THE INVENTION

The present invention relates to printing, and, more particularly, to a method for position acquisition for use with a hand-operated printer.

### BACKGROUND OF THE INVENTION

A typical desktop ink jet printer is a stationary apparatus that includes a reciprocating printhead carrier that carries a printhead in a main scan direction, and includes a drive roller assembly that advances a print medium in a sub-scan direction relative to the printhead. To determine a printhead position relative to a print medium, a typical desktop ink jet printer includes an encoder strip running parallel to the main scan direction for determining the printhead position in the main scan direction, i.e., along the X-axis, and monitors the rotation of the drive roller assembly to determine an amount of print medium feed in the sub-scan direction, e.g., along the Y-axis.

A relatively new type of printer is a hand-operated printer, also sometimes referred to as a hand-held printer or hand printer. In contrast to a desktop printer, a hand-operated printer is moved manually and randomly in its entirety relative to the print medium, such as paper or other surface to be printed, and does not include a drive mechanism for positioning a printhead relative to the print medium. In other words, the hand-operated printer is manually moved over the print medium by way of a motive force exerted via a user's hand.

An optical encoder typically is used to provide position feedback of relative motion between the hand-operated printer and the print medium. In theory, the hand-operated printer senses the position on the print medium and activates printing whenever the area under the print element matches an unprinted section of a latent image, i.e., the portion of the image yet to be printed. A hand-operated printer navigates by continually updating its position with calculations of data from sustained sampling of information. However, errors in the position information occur, and such errors in position are often compounded over multiple print swaths, resulting in defects in the printed image where print swaths do not well align. If navigation during printing is lost, the printed page may be spoiled since reacquisition of the actual position of the hand-operated printer relative to a previously printed portion of the image on the print medium is unlikely. Position may be lost for several reasons, including exceeding operations (e.g., speed) parameters and lifting the printhead and sensor of the hand-operated printer off the print medium.

### SUMMARY OF THE INVENTION

The present invention provides for position acquisition for a hand-operated printer, and may facilitate the convenient reacquisition of navigation if navigation is lost during printing.

The terms “first” and “second” preceding an element name, e.g., first sensor, second sensor, etc., are used for identification purposes to distinguish between similar elements, and are not intended to necessarily imply order, nor are the terms “first” and “second” intended to preclude the inclusion of additional similar elements.

The invention, in one form thereof, is directed to method for position acquisition for use with a hand-operated printer having a first sensor and a second sensor. The method includes activating the hand-operated printer to make navigation calculations that are based on reading the first sensor and the second sensor; moving the hand-operated printer until a field of view of each of the first sensor and the second sensor are simultaneously located on a first edge of a print medium to define a zero-crossing point of a first navigational axis; subsequently moving the hand-operated printer until the field of view of each of the first sensor and the second sensor are simultaneously located on a second edge of the print medium to define a zero-crossing point of a second navigational axis; and defining a rectilinear grid based on the first navigational axis and the second navigational axis for association with the print medium.

The invention, in another form thereof, is directed to a hand-operated printer including a body. A printing mechanism is coupled to the body. A first sensor is mounted to the body, and a second sensor is mounted to the body. A controller is communicatively coupled to each of the printing mechanism, the first sensor and the second sensor. The controller executes program instructions to perform the acts of reading a signal output received from each of the first sensor and the second sensor to make navigation calculations; defining a zero-crossing point of a first navigational axis when the hand-operated printer is moved to a position wherein a field of view of each of the first sensor and the second sensor are simultaneously located on a first edge of a print medium; defining a zero-crossing point of a second navigational axis when the hand-operated printer is moved to a position wherein the field of view of each of the first sensor and the second sensor are simultaneously located on a second edge of the print medium; and defining a rectilinear grid based on the first navigational axis and the second navigational axis for association with the print medium.

The invention, in still another form thereof, is directed to a method for position acquisition for use with a hand-operated printer having a first sensor and a second sensor. The method includes activating the hand-operated printer to make distance and direction calculations relating to movement of the hand-operated printer based on reading the first sensor and the second sensor; moving the hand-operated printer until a field of view of each of the first sensor and the second sensor are simultaneously located on a first edge of a print medium to define a zero-crossing point of a first navigational axis; subsequently moving the hand-operated printer until the field of view of each of the first sensor and the second sensor are simultaneously located on a second edge of the print medium to define a zero-crossing point of a second navigational axis; and determining a position of a printing mechanism of the hand-operated printer on the print medium with respect to the first navigational axis and the second navigational axis.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a hand-operated printer in accordance with an embodiment of the present invention.

FIG. 2 is a bottom view of the hand-operated printer of FIG. 1.

FIG. 3 is a general diagrammatic representation of the hand-operated printer of FIG. 1.

FIG. 4 is a flowchart of a method for position acquisition for use with a hand-operated printer, in accordance with an embodiment of the present invention.

FIG. 5A is a diagrammatic representation of the use of hand-operated printer to identify at least two edges of a print medium.

FIG. 5B is a diagrammatic representation of the generation of navigational axes and a rectilinear grid that is associated with the print medium of FIG. 5A.

Corresponding reference characters indicate corresponding parts throughout the several views. The exemplifications set out herein illustrate an embodiment of the invention, and such exemplifications are not to be construed as limiting the scope of the invention in any manner

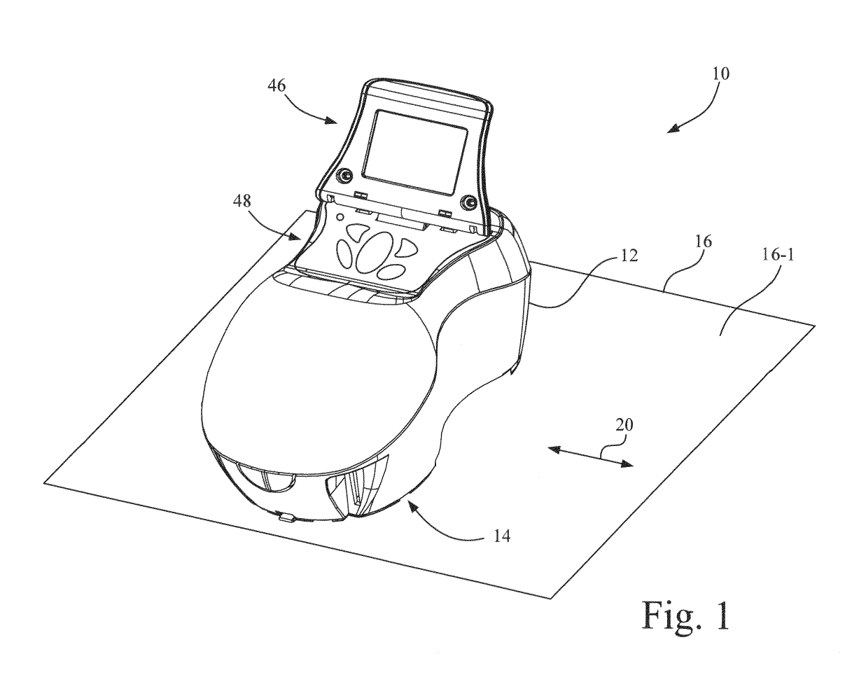

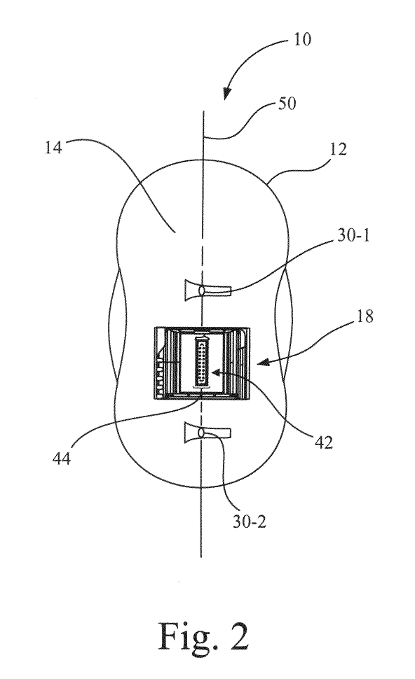

As shown in FIGS. 1 and 2, hand-operated printer 10 includes a body 12. Body 12 is configured with a smooth bottom surface 14 that contacts a print medium 16, such as for example, a sheet of paper, transparency, card stock, fabric, hard surface, soft surface, etc. A printing mechanism 18 is coupled to body 12, as illustrated in FIG. 2.

During a hand printing operation, as illustrated in FIG. 1, a user provides the motive force to provide movement of hand-operated printer 10 relative to print medium 16. Movement of the hand-operated printer 10 relative to print medium 16 along a scan path 20, e.g., a scan axis, results in relative movement of printing mechanism 18 with respect to a printing surface 16-1 of print medium 16 along scan path 20. The term “scan path” is intended to include both linear and non-linear movement of hand-operated printer 10. The smooth surface 14 of body 12 contacts print medium 16 to provide the desired spacing between printing mechanism 18 and printing surface 16-1 of print medium 16.

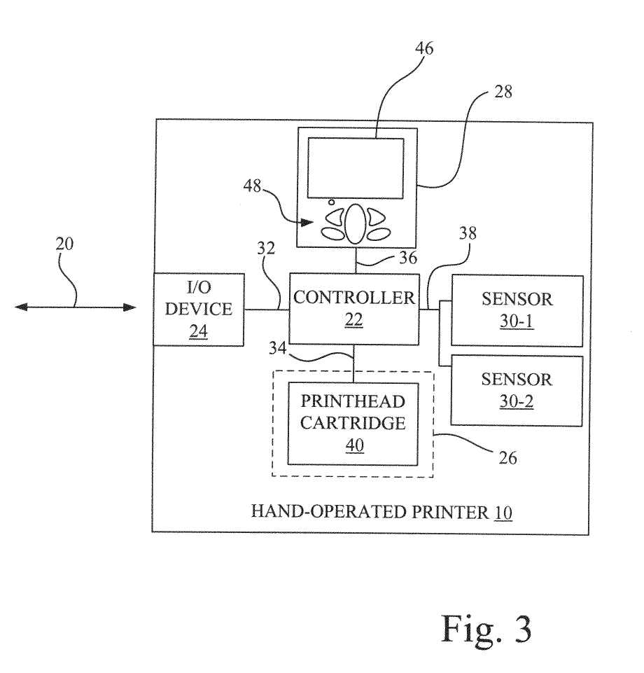

FIG. 3 is a general diagrammatic representation of hand-operated printer 10. Hand-operated printer 10 may be, for example, a hand-operated ink jet printer, and may include a controller 22, an input/output (I/O) device 24, a cartridge receptacle 26, an operator panel 28, a first sensor 30-1, and a second sensor 30-2. Each of controller 22, 1/0 device 24, cartridge receptacle 26, an operator panel 28, sensor 30-1, and sensor 30-2 are mounted to body 12.

Controller 22 includes a processor unit and associated memory, and may be formed as one or more Application Specific Integrated Circuits (ASIC). Controller 22 executes program instructions to perform data processing and formatting, facilitate printing control, and/or facilitate device interaction with respect to one or more of a plurality of devices in communication with controller 22. Controller 22 is communicatively coupled to I/O device 24 via communications link 32. Controller 22 is communicatively coupled to cartridge receptacle 26 via a communications link 34. Controller 22 is communicatively coupled to operator panel 28 via communications link 36. Controller 22 is communicatively coupled to each of sensors 30-1 and 30-2 via a communications link 38.

As used herein, the term “communications link” generally refers to structure that facilitates electronic communication between components, and may operate using wired or wireless technology.

I/O device 24 may be configured in a variety of ways, depending on the source and or destination of the communicated content. For example, I/O device 24 may be a wired, e.g., USB, or wireless, e.g., IEEE 802.XX, communication device that provides a communications link to a source of image content, such as for example, a memory card reader and associated memory card. Alternatively, I/O device 24 may be a host computer, or some other intelligent device, such as a digital camera, that may supply image data for printing by hand-operated printer 10.

Cartridge receptacle 26, for example, may be formed in body 12 and configured for receiving and mounting at least one printhead cartridge 40. Cartridge receptacle 26 holds printhead cartridge 40 in a fixed position relative to hand-operated printer 10. Printhead cartridge 40 is communicatively coupled to controller 22 via communications link 34. As shown in the example of FIG. 3, printhead cartridge 40 includes an ink jet printhead 42 including an array of ink jetting nozzles 44. Printhead cartridge 40 further includes a supply of ink.

Movement of the hand-operated printer 10 relative to print medium 16 results in relative movement of printhead cartridge 40 and ink jet printhead 42 with respect to printing surface 16-1 of print medium 16. The smooth bottom surface 14 of body 12 contacts print medium 16 to provide the desired spacing between printhead 42 and the printing surface 16-1 of print medium 16.

As shown, for example, in FIGS. 1 and 3, operator panel 28 includes a display screen 46, coupled by hinges to body 12, and a plurality of control buttons 48. Display screen 46 and control buttons 48 are communicatively coupled to controller 22 via communications link 36. Display screen 46 may include, for example, a liquid crystal display (LCD) screen having, for example, a resolution (height x width) of 81×101 pixels. Control buttons 48 may be configured to control such functions as, for example, power-ON/OFF, print, menu display, select, cancel, etc. Of course, the number of buttons used may deviate from that illustrated in the exemplary embodiment of hand-operated printer 10 shown in FIGS. 1-3, depending on the actual configuration of the hand-operated printer and the applications for which the hand-operated printer may be used.

If, for example, a user desires to print an image in the primary print mode, such as an image displayed on display screen 46, then hand-operated printer 10 is turned ON, and hand-operated printer 10 is moved relative to print medium 16 along scan path 20. Controller 22 controls printhead 42 to print the image on print medium 16 corresponding to the image selection made by the user. A distance of movement of hand-operated printer 10 in at least one direction is automatically sensed by sensors 30-1 and 30-2, and printing will commence to form an image on print medium 16 after hand-operated printer 10 has moved a predetermined distance to reach a designated print position.

Referring again to FIG. 2, sensors 30-1 and 30-2 are positioned on the underside of hand-operated printer 10 and mounted to body 12. Each of sensors 30-1 and 30-2 is configured to sense movement in one or more directions in determining a position of hand-operated printer 10 relative to print medium 16. In the embodiment shown in FIG. 2, for example, sensors 30-1 and 30-2 are positioned spaced apart along a centerline 50 that passes through ink jet printhead 42, with inkjet printhead 42 being interposed between sensors 30-1 and 30-2.

During operation, sensors 30-1 and 30-2 are sampling continually, for example, hundreds or thousands of times a second. Each of sensors 30-1 and 30-2 detect movement by sensing small changes in the surface features of the surface being sensed, e.g., the surface roughness of printing surface 16-1 of print medium 16, or a discontinuity in print medium 16.

Referring to FIG. 3, each of sensors 30-1 and 30-2 is communicatively coupled to controller 22 via communications link 38. Each of sensors 30-1 and 30-2 may be, for example, a unitary optical sensor including a light source and a detector, each positioned to establish an angle of incidence, e.g., angle of reflection, with respect to the printing surface 16-1 of print medium 16. Each light source may include, for example, a light emitting diode (LED) emitting a predetermined color of light, and each detector may be, for example, a phototransistor whose voltage, or current, output varies as a function of the intensity of the reflected light that it receives. The output of each respective phototransistor of sensors 30-1 and 30-2 is processed by controller 22. From the sample information provided by sensors 30-1 and 30-2, controller 22 makes navigation calculations, e.g., controller 22 calculates a direction and distance of movement of hand-operated printer 10.

Sensors 30-1 and 30-2 are located at a fixed location on hand-operated printer 10 in relation to printing mechanism 18, e.g., ink jet printhead 42. Accordingly, by knowing the relative position of sensors 30-1 and 30-2 with respect to an object, it is possible to determine the relative position of printing mechanism 18, e.g., ink jet printhead 42, with respect to that same object. Thus, in accordance with the present invention, the position of sensors 30-1 and 30-2 with respect to multiple edges of print medium 16 is determined and recorded to facilitate an accurate determination of the position of printing mechanism 18, e.g., ink jet printhead 42, of hand-operated printer 10 with respect to any point, e.g., a start printing position, on print medium 16.

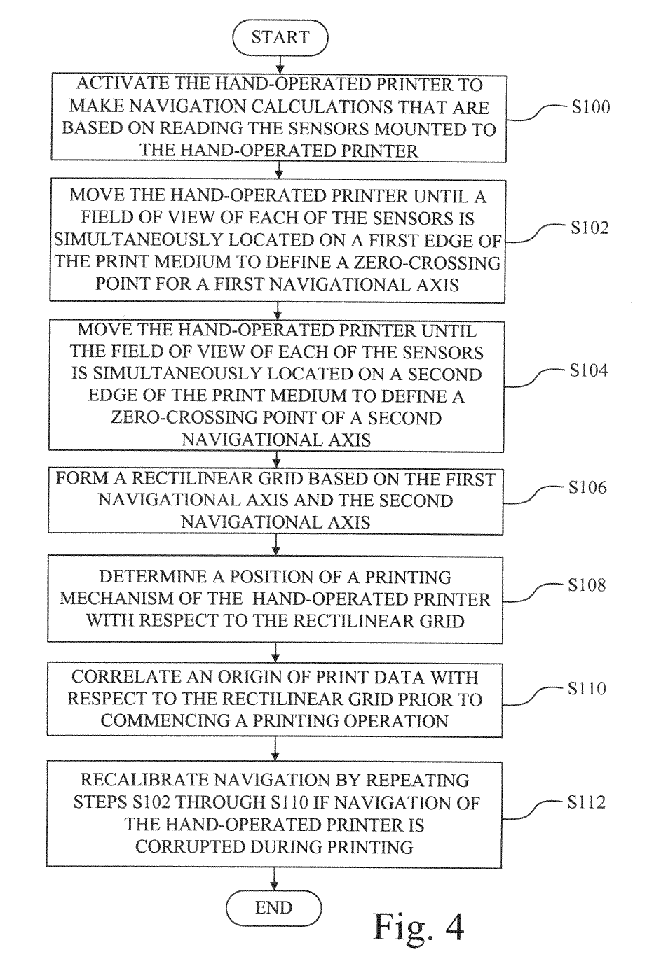

FIG. 4 is a flowchart of a method for position acquisition for use with a hand-operated printer, in accordance with an embodiment of the present invention.

At step S100, for example, with hand-operated printer selected to be in a setup mode, hand-operated printer 10 is activated to make navigation calculations that are based on reading sensor 30-1 and sensor 30-2. Those skilled in the art will recognize that additional sensors may be used, if desired. Controller 22 executes program instructions to read output signals received from each of sensor 30-1 and sensor 30-2 to make navigation calculations. Navigation calculations may be made, for example, by a navigation program executing on controller 22. The navigation program may use, for example, trigonometric functions and geometric rules in converting vector information derived from the output of sensor 30-1 and sensor 30-2 into rectilinear information, e.g., X-Y information, or vice-versa.

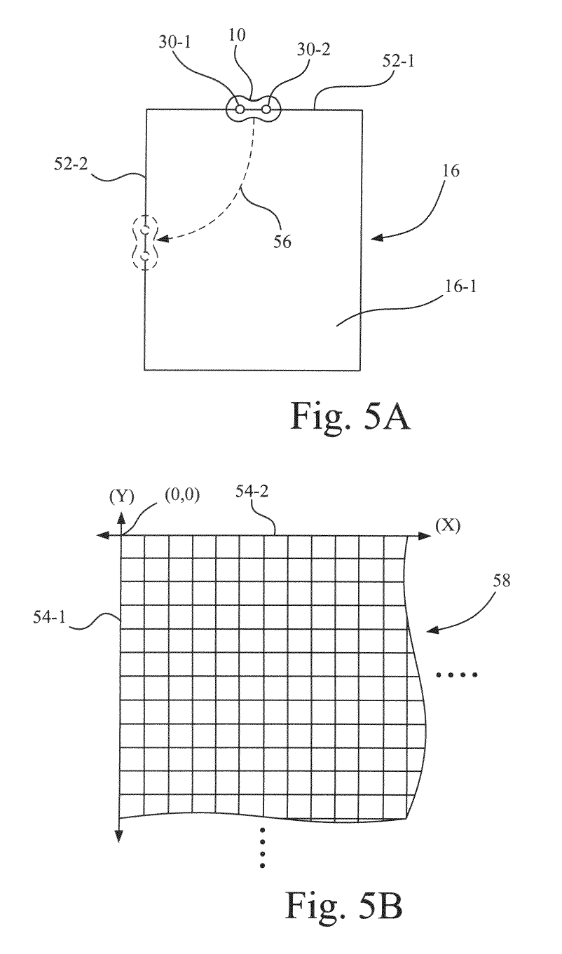

At step S102, and referring to FIG. 5A, hand-operated printer 10 is moved until a field of view of each of sensor 30-1 and sensor 30-2 is simultaneously located on a first edge 52-1, e.g., top edge, of print medium 16 to define a zero-crossing point for a first navigational axis 54-1, as illustrated in FIG. 5B. The field of view may be, for example, about one millimeter horizontally and vertically. In the present example, controller 22 executes program instructions to define the zero-crossing point of first navigational axis 54-1 when hand-operated printer 10 is moved to a position wherein the field of view of each of sensor 30-1 and sensor 30-2 are simultaneously located on first edge 52-1 of print medium 16. At this stage, the zero-crossing point is fixed in one dimension, e.g., the zero-crossing point on the Y-axis (vertical axis) is fixed.

Controller 22 executes program instructions for providing a first indication on display screen 46 when the zero-crossing point of first navigational axis 54-1 is successfully determined. The indication may be, for example, in the form of two lights, corresponding respectively to sensors 30-1 and 30-2, which illuminate when the field of view of each of sensor 30-1 and sensor 30-2 is simultaneously located on first edge 52-1 of print medium 16 to define the zero-crossing point of first navigational axis 54-1.

At step S104, hand-operated printer 10 is subsequently moved until the field of view of each of sensor 30-1 and sensor 30-2 is simultaneously located on a second edge 52-2, e.g., left edge, of print medium 16 to define a zero-crossing point of a second navigational axis 54-2, as illustrated in FIG. 5B. In the example of FIG. 5A, first edge 52-1 of print medium 16 is substantially perpendicular to second edge 52-2 of print medium 16. Controller 22 executes program instructions to define the zero-crossing point of second navigational axis 54-2 when hand-operated printer 10 is moved to a position wherein the field of view of each of sensor 30-1 and sensor 30-2 are simultaneously located on first edge 52-2 of print medium 16. At this stage, the zero-crossing point is fixed in the other dimension, e.g., the zero-crossing point on the X-axis (horizontal axis) is fixed. Thus, second navigational axis 54-2 is substantially perpendicular to first navigational axis 54-1, and intersect at zero-crossing points (0,0) as illustrated in FIG. 5B.

Step S104 may be performed, for example, by sweeping an arc 56 with hand-operated printer 10 from first edge 52-1 of print medium 16 to second edge 52-2 of print medium 16 with hand-operated printer 10 making navigation calculations to track a distance and direction of movement of hand-operated printer 10. For example, second navigational axis 54-2 is determined relative to first navigational axis 54-1 by controller 22 while making navigation calculations to track a distance and direction of movement of hand-operated printer 10. In this example, arc 56 corresponds to a rotation of hand-operated printer by about 90 degrees.

Controller 22 executes program instructions for providing a second indication on display screen 46 when the zero-crossing point on second navigational axis 54-2 is successfully determined, The indication may be, for example, in the form of two lights, corresponding respectively to sensors 30-1 and 30-2, which illuminate when the field of view of each of sensor 30-1 and sensor 30-2 is simultaneously located on second edge 52-2 of print medium 16 to define the zero-crossing point of second navigational axis 54-2.

The accuracy of the determinations at steps S 102 and S104 are dependent, in part, on the spacing between sensor 30-1 and sensor 30-2. For example, a wider spacing between sensor 30-1 and sensor 30-2 will provide a more accurate determination of an edge of print medium 16 and the zero-crossing on a navigation axis associated with that edge of print medium 16 then will a narrower spacing between sensor 30-1 and sensor 30-2. Also, navigational axes 54-1 and 54-2 are defined without the necessity of positioning hand-operated printer 10 at a corner of print medium 16 where edges 52-1 and 52-2 intersect, but rather, hand-operated printer 10 may be moved to any position along edges 52-1 and 52-2, and in either order, e.g., from edge 52-1 to edge 52-2, or from edge 52-2 to edge 52-1.

At step S106, a rectilinear grid 58 is formed based on first navigational axis 54-1 and second navigational axis 54-2 for association with print medium 16, e.g., by scaling each of first navigational axis 54-1 and second navigational axis 54-2 beginning at (0,0). The horizontal and vertical resolutions of rectilinear grid 58 may be selected to correspond to a desired print density, e.g., 600 dots per inch (DPI). For example, controller 22 executes program instructions to calculate a matrix forming rectilinear grid 58 associated with print medium 16 based on the positions of first navigational axis 54-1 and second navigational axis 54-2.

At step S108, a position of a printing mechanism 18 of hand-operated printer 10 on print medium 16 is determined with respect to rectilinear grid 58. For example, with hand-operated printer 10 being selected to be in a printing mode, controller 22 executes program instructions for determining a position of printing mechanism 16, e.g., ink jet printhead 42 of hand-operated printer 10 on print medium 16 with respect to rectilinear grid 58.

At step S110, an origin of print data is correlated with respect to rectilinear grid 58 prior to commencing a printing operation. For example, controller 22 process print data that has associated therewith an origin. Controller 22 executes program instructions for correlating the origin of print data with respect to rectilinear grid 58 prior to commencing a printing operation. In particular, the user positions hand-operated printer 10 on print medium 16 at the desired start print position. The navigation program continually executed by controller 22 of hand-operated printer 16 determines the present start print position with respect to rectilinear coordinates of rectilinear grid 58, and associates the origin of the print data with the start print position of the hand-operated printer.

At step S112, if at any time during printing the navigation of hand-operated printer 10 is corrupted, such as if hand-operated printer 10 is lifted off of print medium 16, the navigation may be recalibrated by repeating steps S102 through S110 to re-acquire the current position of hand-operated printer 10. In some embodiments, controller 22 executes program instructions that provide an audio, visual, or tactile indication (or some combination thereof), notifying a user that the navigation process has been corrupted. The recalibration steps set forth above allow the hand-operated printer 10 to facilitate the convenient reacquisition of navigation if navigation is lost during printing. Accordingly, the time and expense required to restart printing on a current page, or to reprint spoiled pages, may be reduced.

While this invention has been described with respect to an embodiment of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for position acquisition for use with a hand-operated printer having a first sensor and a second sensor, comprising:
activating said hand-operated printer to make navigation calculations that are based on reading said first sensor and said second sensor;
moving said hand-operated printer until a field of view of each of said first sensor and said second sensor are simultaneously located on a first edge of a print medium to define a zero-crossing point of a first navigational axis;
subsequently moving said hand-operated printer until said field of view of each of said first sensor and said second sensor are simultaneously located on a second edge of said print medium to define a zero-crossing point of a second navigational axis; and
defining a rectilinear grid based on said first navigational axis and said second navigational axis for association with said print medium.

2. The method of claim 1, wherein said subsequently moving includes sweeping an arc with said hand-operated printer from said first edge of said print medium to said second edge of said print medium with said hand-operated printer making said navigation calculations to track a distance and direction of movement of said hand-operated printer.

3. The method of claim 1, wherein said second navigational axis is substantially perpendicular to said first navigational axis.

4. The method of claim 1, further comprising determining a position of a printing mechanism of said hand-operated printer on said print medium with respect to said rectilinear grid.

5. The method of claim 1, further comprising correlating an origin of print data with respect to said rectilinear grid prior to commencing a printing operation.

6. The method of claim 5, wherein if during printing navigation of hand-operated printer is corrupted, the method repeating the acts of moving, subsequently moving, and defining a rectilinear grid to re-acquire the current position of said hand-operated printer.

7. The method of claim 1, further comprising providing a first indication to a user when said zero-crossing point of said first navigational axis is successfully determined, and providing a second indication to said user when said zero-crossing point of said second navigational axis is successfully determined.

8. The method of claim 1, said hand-operated printer having a controller executing program instructions for reading said first sensor and said second sensor, for performing said navigation calculations, and for defining said rectilinear grid

9. A hand-operated printer, comprising:
a body;
a printing mechanism coupled to said body;
a first sensor mounted to said body;
a second sensor mounted to said body; and
a controller communicatively coupled to each of said printing mechanism, said first sensor and said second sensor, said controller executing program instructions to perform the acts of:
reading a signal output received from each of said first sensor and said second sensor to make navigation calculations;
defining a zero-crossing point of a first navigational axis when said hand-operated printer is moved to a position wherein a field of view of each of said first sensor and said second sensor are simultaneously located on a first edge of a print medium;
defining a zero-crossing point of a second navigational axis when said hand-operated printer is moved to a position wherein said field of view of each of said first sensor and said second sensor are simultaneously located on a second edge of said print medium; and
defining a rectilinear grid based on said first navigational axis and said second navigational axis for association with said print medium.

10. The hand-operated printer of claim 9, wherein said second navigational axis is determined relative to said first navigational axis by said controller making said navigation calculations to track a distance and direction of movement of said hand-operated printer as said hand-operated printer is swept in an arc from said first edge of said print medium to said second edge of said print medium.

11. The hand-operated printer of claim 9, wherein said second navigational axis is substantially perpendicular to said first navigational axis.

12. The hand-operated printer of claim 9, said controller executing program instructions for determining a position of said printing mechanism of said hand-operated printer on said print medium with respect to said rectilinear grid.

13. The hand-operated printer of claim 9, said controller executing program instructions for correlating an origin of print data with respect to said rectilinear grid prior to commencing a printing operation.

14. The hand-operated printer of claim 9, further comprising a display screen communicatively coupled to said controller, said controller executing program instructions for providing a first indication on said display screen when said zero-crossing point of said first navigational axis is successfully determined, and providing a second indication on said display screen when said zero-crossing point of said second navigational axis is successfully determined.

15. A method for position acquisition for use with a hand-operated printer having a first sensor and a second sensor, comprising:
activating said hand-operated printer to make distance and direction calculations relating to movement of said hand-operated printer based on reading said first sensor and said second sensor;
moving said hand-operated printer until a field of view of each of said first sensor and said second sensor are simultaneously located on a first edge of a print medium to define a zero-crossing point of a first navigational axis;
subsequently moving said hand-operated printer until said field of view of each of said first sensor and said second sensor are simultaneously located on a second edge of said print medium to define a zero-crossing point of a second navigational axis; and
determining a position of a printing mechanism of said hand-operated printer on said print medium with respect to said first navigational axis and said second navigational axis.

16. The method of claim 15, wherein said subsequently moving includes sweeping an arc with said hand-operated printer from said first edge of said print medium to said second edge of said print medium with said hand-operated printer making said distance and direction calculations to determine said second navigational axis relative to said first navigational axis.

17. The method of claim 15, wherein said second navigational axis is substantially perpendicular to said first navigational axis.

18. The method of claim 15, further comprising defining a rectilinear grid based on said first navigational axis and said second navigational axis for association with said print medium.

19. The method of claim 18, further comprising correlating an origin of print data with respect to said rectilinear grid prior to commencing a printing operation.

20. The method of claim 15, further comprising providing a first indication to a user when said zero-crossing point of said first navigational axis is successfully determined, and providing a second indication to a user when said zero-crossing point of said second navigational axis is successfully determined.
